(19) United States
(12) Patent Application Publication
(10) Pub. No.: US 2022/0057060 A1
(43) Pub. Date: Feb. 24, 2022

(54) MULTI-COLOR LIGHTING DEVICE

(71) Applicant: LUMILEDS LLC, San Jose, CA (US)

(72) Inventor: Marc Droegeler, Aachen (DE)

(73) Assignee: LUMILEDS LLC, San Jose, CA (US)

(21) Appl. No.: 16/999,577

(22) Filed: Aug. 21, 2020

(51) Int. Cl. F21S 41/141; F21S 41/24; F21K 9/61; F21S 41/19

(52) U.S. Cl. CPC F21S 41/141; F21S 41/192; F21K 9/61; F21S 41/24

(57) ABSTRACT

Methods, devices and system are described herein. A lighting device includes an electrically insulating layer and at least one first light emitting element and at least one second light emitting element on the electrically insulating layer. The at least one first light emitting element is configured to emit light of a first color and the at least one second light emitting element is configured to emit light of a second color. At least one electrical contact element is at least in part on the electrically insulating layer and is electrically coupled to at least one of the at least one first light emitting element or the at least one second light emitting element.

### FIELD OF INVENTION

The present invention relates to a lighting device, in particular a light-emitting diode (LED) based lighting device, to an automotive lighting system, and to a method for producing a lighting device.

### BACKGROUND

Lighting devices based on Light Emitting Diodes (LEDs) may be advantageous in terms of light output and energy efficiency and may, therefore, be welcome replacements for conventional light sources, such as filament lamps in automotive applications.

### SUMMARY

Methods, devices and system are described herein. A lighting device includes an electrically insulating layer and at least one first light emitting element and at least one second light emitting element on the electrically insulating layer. The at least one first light emitting element is configured to emit light of a first color and the at least one second light emitting element is configured to emit light of a second color. At least one electrical contact element is at least in part on the electrically insulating layer and is electrically coupled to at least one of the at least one first light emitting element or the at least one second light emitting element.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims It should be further understood that the drawings are not drawn to scale and are merely intended to conceptually illustrate the structures and procedures described herein.

### BRIEF DESCRIPTION OF THE DRAWING(S)

Examples of the invention will now be described in detail with reference to the accompanying drawings, in which:

FIG. 1A exemplarily illustrates a lighting device according to an embodiment;

FIG. 1B illustrates an exemplary circuit diagram of the lighting device of FIG. 1A;

FIG. 1C illustrates an exemplary circuit diagram of the lighting device of FIG. 1A;

FIG. 2A exemplarily illustrates a lighting device according to an embodiment;

FIG. 2B illustrates an exemplary circuit diagram of the lighting device of FIG. 2A;

FIG. 3 illustrates an exemplary diagram of an example vehicle headlamp system that may incorporate the lighting device of FIG. 1A or FIG. 2A; and

FIG. 4 illustrates an exemplary diagram of another example vehicle headlamp system.

### DETAILED DESCRIPTION OF THE PREFERRED EMBODIMENT(S)

A provision of such lighting devices faces challenges in particular in placement accuracy of light sources with respect to complementary optical systems (such as reflectors or light guides) and thermal management. In addition, LED based automotive lighting systems, such as daytime running lights or turn signal lights, may rely on customized and complex solutions hampering their provision by mass-production.

Embodiments described herein provide for a lighting device that may allow for an improved thermal management that allows the device to be used with existing complementary optical systems and that supports reducing complexity of the overall system. Embodiments described herein may additionally or alternatively provide a corresponding automotive lighting system and a method for producing a lighting device.

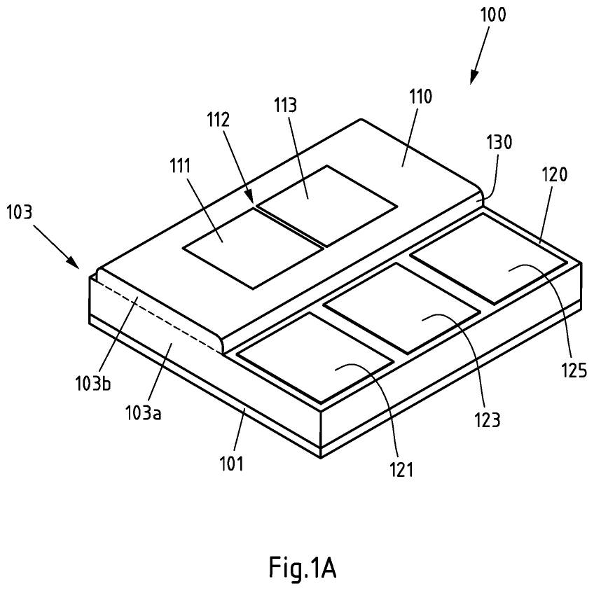

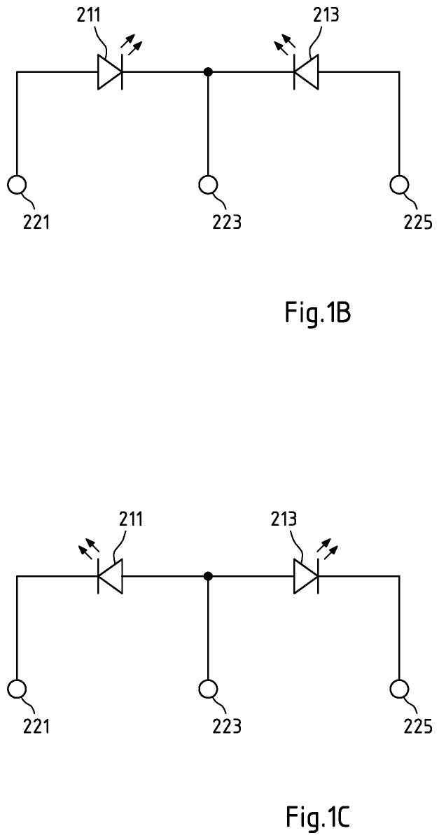

FIG. 1A shows a lighting device 100 comprising an interface layer 101 and an electrically insulating layer 103 arranged on the interface layer 101. The lighting device 100 may further include a mounting portion 110 that includes respective portions of the interface layer 101 and the electrically insulating layer 103. A first light emitting element 111 and a second light emitting element 113 may be mounted to the mounting portion 110, thereby mechanically adjusting their respective positions within the lighting device 100. A gap 112 may be provided in between the first and second light emitting elements 111, 113.

By providing the at least one first light emitting element and the at least one second light emitting element on the electrically insulating layer, a compact and stable construction can be achieved. In other words, the electrically insulating layer may serve as a support structure for the at least one first light emitting element and/or for the at least one second light emitting element and may thus be seen as a backbone of the lighting device. Further, by providing the at least one first light emitting element and the at least one second light emitting element arranged on the electrically insulating layer, which in turn may be arranged on the interface layer, a path may be provided for directing heat generated by the light emitting elements away via the interface layer. In other words, the specific arrangement of these components may advantageously enable a beneficial heat management.

In order to facilitate an advantageous heat transport, in exemplary embodiments, the interface layer may be thermally conductive. For example, a thermal conductivity of the interface layer may be, in an exemplary embodiment, larger than 100 W/(m*K). Suitable thermal conductivity may be achieved by appropriately selecting a material of or comprised by the interface layer. In other words, in an exemplary embodiment, the interface layer may include or be metal, such as aluminum (Al), copper (Cu) and/or gold (Au). In a particular exemplary embodiment, the interface layer includes or is gold-coated copper.

In exemplary embodiments, the interface layer may be in direct mechanical contact with the electrically insulating layer. In this way, a thermal coupling between the interface layer and the electrically insulating layer may be achieved, which may enable an improved thermal management of the lighting device as heat generated by the at least one first and the at least one second light emitting element arranged on the insulating layer is advantageously guided away via the interface layer. In exemplary embodiments, a thickness of the electrically insulating layer may be less than or equal to 0.5 mm, less than or equal to 0.4 mm, and/or less than or equal to 0.3 mm. Such a thin electrically insulating layer may be particularly beneficial for an improved heat transport through the electrically insulating layer. Advantageously enabling this effect, in exemplary embodiments, the interface layer may correspond to or include a plate or substrate that allows an improved coupling between this structure and the electrically insulating layer. In exemplary embodiments, the interface layer may be further coupled with a heatsink for further guiding heat away from the lighting device.

In exemplary embodiments, the interface layer may be an interface plate, such as including or essentially consisting of a metal. In exemplary embodiments, the metal may have a thermal conductivity of equal to or more than 100 W/(m*K), such as more than 300 W/(m*K).

In an exemplary embodiment, the electrically insulating layer may be in direct mechanical contact with the interface plate. As mentioned, direct mechanical contact between the electrical insulating layer and the interface layer may enable advantageous thermal coupling of these components and, in turn, allow for heat generated by the at least one first and the at least one second light emitting element to be advantageously guided away.

The electrically insulating layer may be formed of any suitable material, such as a suitable plastic material. However, ceramic materials may be of particular advantage. In an exemplary embodiment, the electrically insulating layer may include or be a ceramic material and/or a material with a thermal conductivity of more than 10 W/(m*K) or more than 100 W/(m*K). In a particular exemplary embodiment, the electrically insulating layer may include or be aluminum nitride (AlN). In this way, suitable mechanical stiffness and reliability can be achieved using a material with high thermal conductivity. In an exemplary embodiment, the electrically insulating layer and/or the lighting device may not include an Insulated Metal Substrate (IMS).

Further, electrically insulating layer 103 may include a supporting portion 103a and a covering portion 103b. While supporting portion 103a may advantageously provide the overall mechanical stability of lighting device 100, the covering portion 103b may protect the first light emitting element 111 and second light emitting element 113 against environmental conditions, such as dust or humidity, and enhance heat dissipation by increasing the contact area of the first and second light emitting element 111, 113 with electrically insulating layer 103.

In exemplary embodiments, the at least one first light emitting element and/or the at least one second light emitting element may corresponds to or include a light emitting diode (LED). In exemplary embodiments, the at least one first light emitting element and/or the at least one second light emitting element may correspond to or include one or more LED dies. In other words, while the light emitting elements may include further components, the light emitted by the light emitting elements may be, in exemplary embodiments, generated by LEDs. LEDs may be in particular advantageous in terms of energy efficiency and in that LEDs may allow for realizing different shapes and colors in accordance with desired applications.

The at least one first light emitting element and the at least one second light emitting element may be configured to emit light of a first and a second color, respectively. According to a first option, in exemplary embodiments, at least one of the at least one first and the at least one second light emitting element may further include a respective phosphor layer arranged on a corresponding light output surface of the respective at least one of the at least one first light emitting element and the at least one second light emitting element. By appropriately selecting a phosphor coating, a color of light emitted from a corresponding light emitting element may be suitably adjusted. Alternatively, or additionally, in exemplary embodiments, at least one of the at least one first and the at least one second light emitting element may be configured as a light emitting element for directly emitting light of the first and/or the second color.

In exemplary embodiments, the first color may be different from the second color. The first and/or the second color may be, for example, selected from: a white color, an amber color, or a cyan color.

In exemplary embodiments, the first color may be a white color such that the at least one first light emitting element is configured to emit white light. In exemplary embodiments, light of the white color may be light comprising a superposition of at least two, or more than two, optical wavelength spectra (e.g., spectral colors). For example, a white color may be realized by a light emitting diode configured for emitting light of blue color provided with a phosphor coating that converts part of the blue light into yellow light, the mixture of blue and yellow light generating a white appearance. Different white colors may be characterized by a respective color temperature. Thereby, in exemplary embodiments, the first color may be a white color having a correlated color temperature (CCT) between 4000K and 6700K.

In exemplary embodiments, the first and/or second color may be a cyan color, (e.g., a color in between blue and green), the at least one first and/or second light emitting element thus being respectively configured to emit light of a cyan color. In exemplary embodiments, light of a cyan color can be characterized by a spectrum of optical wavelengths with a dominant wavelength between 490 nm and 510 nm.

In exemplary embodiments, the second color may be chosen from a red/magenta, green, blue/cyan, orange and/or yellow color or any combination thereof. Thus, in exemplary embodiments, the at least one second light emitting element may be configured to emit red/magenta, green, blue/cyan, orange, yellow and/or amber light.

In exemplary embodiments, the second color may be an amber color (e.g., in between yellow and orange), the at least one second light emitting element thus being configured to emit light of an amber color. In an exemplary embodiment, light of an amber color can be characterized by a spectrum of optical wavelengths with a dominant wavelength between 585 nm and 600 nm.

In a particular exemplary embodiment, the at least one second light emitting element may be a light emitting diode (LED) provided with a suitable phosphor coating and thus configured to emit light of an amber color, such as light with a spectrum of optical wavelength with a dominant wavelength between 585 nm and 600 nm.

Realizing light emission of two different colors with the same lighting device may offer a particular advantage that a number of desired functions can be realized with a single lighting device. In other words, in exemplary embodiments, a white light generated by the lighting device may be used to allow for an illumination function, a cyan light may be used to allow for an autonomous driving mode, and an amber light may be used to allow for a signaling function. This may allow for sharing electrical connection and heat management by at least two light emitting elements, thus advantageously enabling a lighting device architecture offering reduced complexity. For example, being configured for white or cyan light emission, the at least one first light emitting element may be in particular suitable to be employed in a daytime running light mode or an autonomous driving mode, while the at least one second light emitting element, being configured for amber or cyan light emission, may in particular be suitable to be employed in a turn signal mode or an autonomous driving mode.

In exemplary embodiments, the at least one first light emitting element and the at least one second light emitting element may be arranged on and in direct mechanical contact with the electrically insulating layer. Thus, the at least one first light emitting element and the at least one second light emitting element may be in direct thermal coupling with the electrically insulating layer such that heat generated by the light emitting elements can be efficiently dissipated away by the described combined effect of the electrically insulating layer and the interface layer.

In exemplary embodiments, the at least one first light emitting element and the at least one second light emitting element may be arranged adjacent to each other, such that respective light emission surfaces of the at least one first and the at least one second light emitting element are arranged in a common plane. Being arranged adjacent, the at least one first light emitting element and the at least one second light emitting element may be mutually arranged in close proximity (e.g., in direct contact or with only a thin gap provided in between the at least one first light emitting element and the at least one second light emitting element). In exemplary embodiments, the gap between the at least one first light emitting element and the at least one second light emitting element may have a width equal to or less than 25% of a width of the at least one first light emitting element and/or of the at least one second light emitting element, less than 10%, and/or less than 5%. In embodiments, the gap may be filled with air or a different material.

The lighting device 100 may further include a connection portion 120 also including respective portions of the interface layer 101 and the electrically insulating layer 103. Connection portion 120 may further include electrical contact elements 121, 123, 125, thereby allowing for electrically connecting the lighting device 100 to a power supply (not shown). The electrical contact elements 121, 123, 125 may be respectively in electrical contact with the first and second light emitting elements 111, 113 via a lead frame, which may be embedded in interface layer 101 and electrically insulating layer 103 and therefore not visible in the figures.

The connection portion may include respective portions of the interface layer and the electrically insulating layer and at least one electrical contact element. The different thicknesses of the connection portion and the mounting portion may advantageously allow for electrically connecting the at least one electrical contact element to a power supply without hampering light emission and/or propagation, such as without having electrical contact means, such as bonding wires, blocking an optical path of light emitted by the at least one first light emitting element and the at least one second light emitting element. In exemplary embodiments, the mounting portion may include respective portions of the interface layer and the electrically insulating layer. In exemplary embodiments, the portions of the interface layer and the electrically insulating layer comprised by the connection portion may be different from the portions of the interface layer and the electrically insulating layer comprised by the mounting portion.

In exemplary embodiments, the at least one first light emitting element and the at least one second light emitting element may be at least in part received inside of at least one corresponding portion of the mounting portion. The mounting portion may thus support a secure mechanically adjustment of respective positions of the light emitting elements with respect to the lighting device, which may enable a precise placement of the light emitting elements with respect to corresponding (e.g., external) optical systems. Further, being at least partially received by or embedded within the mounting portion, corresponding enhanced contact surfaces may advantageously contribute to a beneficial heat transport by the mounting portion away from the light emitting elements.

As can be taken from the figure, a thickness of the connection portion 120 may be smaller than a thickness of the mounting portion 110, and the connection portion 120 and the mounting portion 110 may be arranged mutually adjacent, thereby forming a step 130 at a transition from the connection portion 120 to the mounting portion 110. In exemplary embodiments, a height of the step may correspond to at least 10% of a maximum thickness of the lighting device, at least 20% of a maximum thickness of the lighting device, and/or at least 40% of a maximum thickness of the lighting device. A lighting device comprising a step may advantageously allow for a less complex manufacturing process while protecting the at least one first and/or at least one second light emitting element against environmental conditions such as dust or humidity.

In exemplary embodiments, the at least one electrical contact element may be arranged on, or in direct mechanical contact with, the electrically insulating layer, and may be configured for electrically connecting the at least one first light emitting element and/or the at least one second light emitting element to a power source. Placing the at least one electrical contact element on top of the electrically insulating layer instead of contacting the lighting device from, for example, its bottom side, may advantageously enable use of a large, metallic, thermal pad as the interface layer, thus reducing the thermal resistance of the lighting device.

In other words, by placing the at least one electrical contact element on the top side of the lighting device, space may be provided for use of a large thermal pad provided at a bottom side of the lighting device, which otherwise may be partially covered by electrical contacts. Thus, in exemplary embodiments, the interface layer may correspond to or include a thermal pad, such as a thermal pad including or being metal. In exemplary embodiments, the thermal pad may cover essentially an entire bottom face of the lighting device, in particular wherein the bottom face is opposite of a face of the lighting device at which the at least one first and the at least one second light emitting elements are arranged.

In an exemplary embodiment, the at least one electrical contact element includes an essentially planar contact portion and may be arranged on the electrically insulating layer within the connection portion. Thereby, essentially planar may be understood such that in an exemplary embodiment, a height of the essentially planar contact portion is significantly smaller than a length and/or width of the essentially planar contact portion. In exemplary embodiments, the height of the essentially planar contact portion may amount to less than or equal to 10% of the length and/or width of the essentially planar contact portion or, in some embodiments, less than or equal to 5%.

In exemplary embodiments, the essentially planar contact portion may be arranged essentially parallel to a bottom surface of the lighting device and/or to respective light emitting surfaces of the at least one first light emitting element and/or the at least one second light emitting element. Being arranged essentially parallel may be understood such that, in an exemplary embodiment, an angle formed by the essentially planar contact portion and respective light emitting surfaces may be smaller than 10°, smaller than 5°, and/or smaller than 3°. Arranging the essentially planar contact portion essentially parallel to a bottom surface of the lighting device and/or to respective light emitting surfaces may advantageously result in a uniform shape of the lighting device, thereby offering reduced complexity in terms of an overall shape of the lighting device and simplifying the electrical connection of the lighting device.

In an exemplary embodiment, the at least one essentially planar electrical contact element may correspond to or comprise at least one contact pad and/or bond pad. Using essentially planar electrical contact elements may be advantageous as may support enhancing robustness of the lighting device and contribute to achieving a particularly reliable electrical connection. Using such contact elements may avoid, for example, that portions of the contact element stick out and help to provide the lighting device less prone to damage (e.g., during manufacturing and/or upon mounting).

In exemplary embodiments, the at least one electrical contact element may be located on a topside of the lighting device, where the topside of the lighting device may correspond to a light emitting side of the lighting device. In other words, in exemplary embodiments, the at least one electrical contact element may be configured for being electrically contacted from the top. Such an architecture may allow for a large, metallic, interface layer at the bottom side of the lighting device, thereby advantageously reducing the overall thermal resistance of the lighting device and allowing for an improved heat management.

In exemplary embodiments, the lighting device may include at least three electrical contact elements, two of which may be respectively electrically connected with a corresponding one of the at least one first and the at least one second light emitting element. One of the at least three electrical contact elements may be electrically connected to both of the at least one first light emitting element and the at least one second light emitting element.

Three or more electrical contact elements may advantageously enable independently contacting the at least one first light emitting element and the at least one second light emitting element. In exemplary embodiments, the electrical contact elements may serve as anode and/or cathode for the at least one first light emitting element and/or for the at least one second light emitting element, respectively. Independently contacting the light emitting elements may advantageously enable independently turning the light emitting elements ON or OFF and thus enable use of the light emitting elements in accordance with one or more predetermined modes of operation. Thereby, a mode of operation may, for example, correspond to a daytime running light mode, an autonomous driving mode and/or a mode of using e.g. the at least one second light emitting element as turn signal light.

In exemplary embodiments, the at least one electrical contact element may be electrically connected with the at least one first light emitting element and/or the at least one second light emitting element by means of a lead frame. In an exemplary embodiment, a lead frame may correspond to or comprise a metal structure, such as a metal structure embedded in the lighting device, being configured for carrying electrical power from a power source to the at least one first light emitting element and/or the at least one second light emitting element via the at least one electrical contact element. In other words, in exemplary embodiments, the lead frame may serve for electrically connecting the lighting device to a power source. Using a lead frame, such as a metal lead frame embedded in the lighting device, for electrically connecting the at least one electrical contact element with the at least one first light emitting element and/or the at least one second light emitting element may enable a compact architecture and enhanced thermal conductivity.

FIG. 1B shows an exemplary circuit diagram that illustrates an example of electrically connecting the lighting device 100. Reference numerals 211 and 213 denote the first light emitting element 111 and the second light emitting element 113 of FIG. 1A in this circuit diagram. The light emitting elements may be electrically connected to a power source (not shown) by electrical contact elements 221, 223, 225, thereby allowing for carrying electrical power from the power source to the first light emitting element 211 and the second light emitting element 213. It is noted that, in the illustrated example, electrical contact element 223 is electrically connected to both the first light emitting element 211 and the second light emitting element 213. FIG. 1C shows the circuit diagram of FIG. 1B where a direction of an electrical current is reversed as indicated by a direction illustrated by light emitting elements 211, 213.

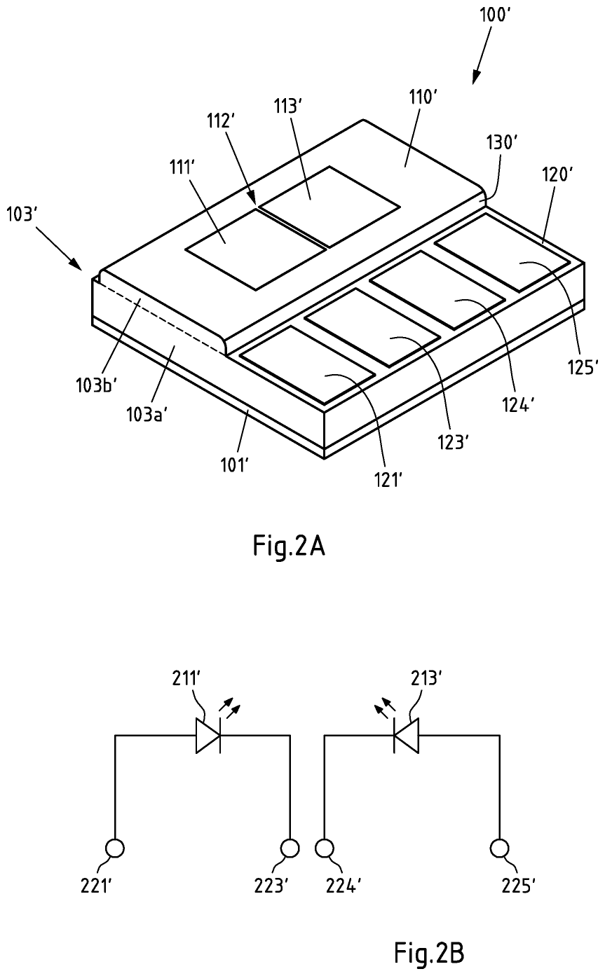

FIG. 2A shows a lighting device 100′ including an interface layer 101′ and an electrically insulating layer 103′ arranged thereon. The lighting device 100′ may further include a mounting portion 110′ including respective portions of the interface layer 101′ and the electrically insulating layer 103′. First and second light emitting elements 111′ and 113′ may be mounted to the mounting portion 110′, and a gap 112′ may be formed in between the first and second light emitting elements 111′, 113′. Electrically insulating layer 103′ may include a supporting portion 103a′ and a covering portion 103b′ offering the same advantages as described above for FIG. 1A.

The lighting device 100′ may further include a connection portion 120′ including respective portions of the interface layer 101′ and the electrically insulating layer 103′. Connection portion 120′ may include electrical contact elements 121′, 123′, 124′, 125′, thereby allowing for electrically connecting the lighting device 100′ to a power supply. A thickness of the connection portion 120′ may be smaller than a thickness of the mounting portion 110′, and the connection portion 120′ and the mounting portion 110′ may be arranged mutually adjacent, thereby forming a step 130′ at a transition from the connection portion 120′ to the mounting portion 110′.

In the example illustrated in FIG. 2A, the lighting device may include at least a first, a second, a third and a fourth electrical contact element. The last at least one first light emitting element may be electrically connected to the first and the second contact element, and the at least one second light emitting element may be electrically connected to the third and the fourth contact element.

FIG. 2B shows an exemplary circuit diagram that may be used for electrically connecting the lighting device 100′. A first light emitting element 211′ and a second light emitting element 213′ may be electrically connected to a power source (not shown) by electrical contact elements 221′, 223′, 224′, 225′, thereby allowing for carrying electrical power from the power source to the first light emitting element 211′ and the second light emitting element 213′.

In exemplary embodiments, a lighting device, such as described above, may be included in an automotive lighting system. In exemplary embodiments, the automotive lighting system may correspond to or include an automotive daylight running system, an automotive autonomous driving indication system, an automotive turn signal lighting system and/or an automotive headlight lighting system. Thereby, such automotive lighting system may include the necessary components including, for example, a controller for controlling power supply to the at least one first and/or the at least one second light emitting element. The controller may be a separate component and/or integrated in an automotive control system for controlling further functions.

In exemplary embodiments, the automotive lighting system may further include at least one optical element configured for shaping a beam of light emitted from the at least one first light emitting element and the at least one second light emitting element. Shaping a beam of light may be understood as adjusting, for example, a direction, intensity, shape or pattern of a beam of light emitted from the at least one first and/or the at least one second light emitting element. Shaping a beam of light emitted from each of the at least one first light emitting element and the at least one second light emitting element with at least one common optical element may advantageously support use of the at least one first light emitting element and the at least one second light emitting element in the automotive lighting system in the at least two predetermined modes of operation. In exemplary embodiments, the at least one optical element may include one or more reflectors and/or lens elements. For example, one or more lens elements may be incorporated in an outer glass portion through which the beam of light is outwards.

In exemplary embodiments, the automotive lighting system may further include a controller configured to respectively control the at least one first and/or the at least one second light emitting element to be turned ON and/or OFF in accordance with at least one predetermined mode of operation. As mentioned, the controller may be a separate controller or may be a subcomponent of a control system. The controller may correspond to a suitable dedicated controller or may correspond to or include a microprocessor.

In exemplary embodiments, the predetermined mode of operation may be at least one of: a daytime running mode wherein the first color is a white color and according to which the at least one first light emitting element is turned ON and the at least one second light emitting element is turned OFF; a turn-signal mode wherein the second color is an amber color and according to which the at least one second light emitting element is, in particular periodically, turned ON and OFF and the at least one first light emitting element is turned OFF; a first autonomous driving mode wherein the first color is a cyan color and according to which the at least one first light emitting element is turned ON and the at least one second light emitting element is turned OFF; a second autonomous driving mode wherein the second color is a cyan color and according to which the at least one first light emitting element is turned OFF and the at least one second light emitting element is turned ON.

Accordingly, in exemplary embodiments, the lighting device may include at least one first light emitting element configured to emit either light of a white color (e.g., for use in the daytime running mode) and/or light of a cyan color (e.g., for use in the first autonomous driving mode), and at least one second light emitting element configured to emit either light of an amber color (e.g. for use in the turn signal mode) or light of a cyan color (e.g. for use in the second autonomous driving mode).

For example, when used as daytime running light or when used in the first autonomous driving mode, the at least one first light emitting element may be turned ON, whereby the at least one second light emitting element may be turned OFF. As a further example, in turn signal mode, the at least one first light emitting element may be turned OFF, and the at least one second light emitting element may be (e.g., periodically) turned ON and OFF to indicate a turn of a vehicle. As a further example, in the second autonomous driving mode, the at least one first light emitting element may be turned OFF, and the at least one second light emitting element may be turned ON to indicate that the vehicle is driving autonomously.

In exemplary embodiments, the automotive lighting system further includes a heatsink, whereby the interface layer may be arranged in contact, such as in direct mechanical contact, with the heat sink for guiding heat generated by the at least one first light emitting element and/or the at least one second light emitting element to the heatsink. This may advantageously enable an enhanced heat management of the automotive lighting system and in particular the lighting device included in it.

A method for producing a lighting device may include providing an electrically insulating layer, providing at least one first light emitting element configured to emit light of a first color, and providing at least one second light emitting element configured to emit light of a second color. The at least one first light emitting element and the at least one second light emitting element may be arranged on the electrically insulating layer. At least one electrical contact element may be provided and arranged at least in part on the electrically insulating layer and electrically connected to the at least one first light emitting element and/or to the at least one second light emitting element.

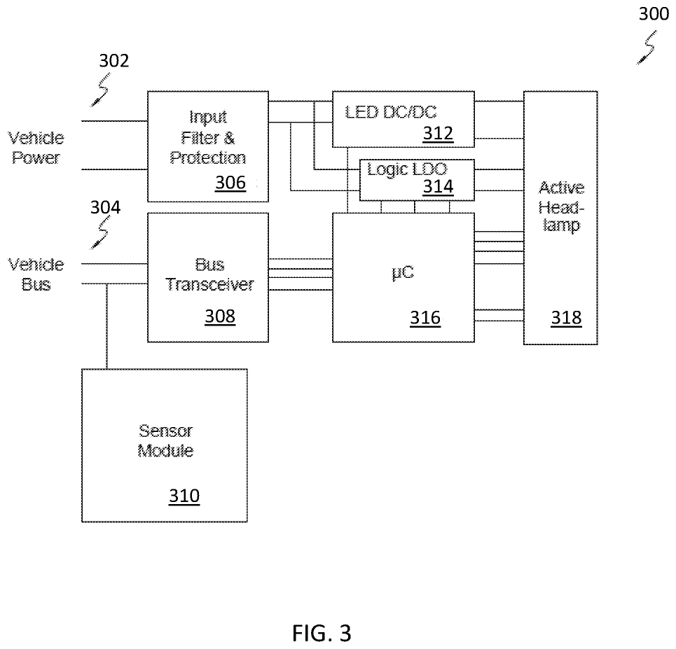

FIG. 3 is a diagram of an example vehicle headlamp system 300 that may incorporate the lighting device 100 or 100′ of FIG. 1A or FIG. 2A. The example vehicle headlamp system 300 illustrated in FIG. 3 includes power lines 302, a data bus 304, an input filter and protection module 306, a bus transceiver 308, a sensor module 310, an LED direct current to direct current (DC/DC) module 312, a logic low-dropout (LDO) module 314, a micro-controller 316 and an active head lamp 318. In embodiments, the active head lamp 318 may include all or part of the lighting device, such as the lighting device 100 or FIG. 1A or the lighting device 100′ of FIG. 2A.

The power lines 302 may have inputs that receive power from a vehicle, and the data bus 304 may have inputs/outputs over which data may be exchanged between the vehicle and the vehicle headlamp system 300. For example, the vehicle headlamp system 300 may receive instructions from other locations in the vehicle, such as instructions to turn on turn signaling or turn on headlamps, and may send feedback to other locations in the vehicle if desired. The sensor module 310 may be communicatively coupled to the data bus 304 and may provide additional data to the vehicle headlamp system 300 or other locations in the vehicle related to, for example, environmental conditions (e.g., time of day, rain, fog, or ambient light levels), vehicle state (e.g., parked, in-motion, speed of motion, or direction of motion), and presence/position of other objects (e.g., vehicles or pedestrians). A headlamp controller that is separate from any vehicle controller communicatively coupled to the vehicle data bus may also be included in the vehicle headlamp system 300. In FIG. 3, the headlamp controller may be a micro-controller, such as micro-controller (μc) 316. The micro-controller 316 may be communicatively coupled to the data bus 304.

The input filter and protection module 306 may be electrically coupled to the power lines 302 and may, for example, support various filters to reduce conducted emissions and provide power immunity. Additionally, the input filter and protection module 306 may provide electrostatic discharge (ESD) protection, load-dump protection, alternator field decay protection, and/or reverse polarity protection.

The LED DC/DC module 312 may be coupled between the filter and protection module 306 and the active headlamp 318 to receive filtered power and provide a drive current to power LEDs in the LED array in the active headlamp 318. The LED DC/DC module 312 may have an input voltage between 7 and 18 volts with a nominal voltage of approximately 13.2 volts and an output voltage that may be slightly higher (e.g., 0.3 volts) than a maximum voltage for the LED array (e.g., as determined by factor or local calibration and operating condition adjustments due to load, temperature or other factors).

The logic LDO module 314 may be coupled to the input filter and protection module 306 to receive the filtered power. The logic LDO module 314 may also be coupled to the micro-controller 316 and the active headlamp 318 to provide power to the micro-controller 316 and/or the silicon backplane (e.g., CMOS logic) in the active headlamp 318.

The bus transceiver 308 may have, for example, a universal asynchronous receiver transmitter (UART) or serial peripheral interface (SPI) and may be coupled to the micro-controller 316. The micro-controller 316 may translate vehicle input based on, or including, data from the sensor module 310. The translated vehicle input may include a video signal that is transferrable to an image buffer in the active headlamp module 318. In addition, the micro-controller 316 may load default image frames and test for open/short pixels during startup. In embodiments, an SPI interface may load an image buffer in CMOS. Image frames may be full frame, differential or partial frames. Other features of micro-controller 316 may include control interface monitoring of CMOS status, including die temperature, as well as logic LDO output. In embodiments, LED DC/DC output may be dynamically controlled to minimize headroom. In addition to providing image frame data, other headlamp functions, such as complementary use in conjunction with side marker or turn signal lights, and/or activation of daytime running lights, may also be controlled.

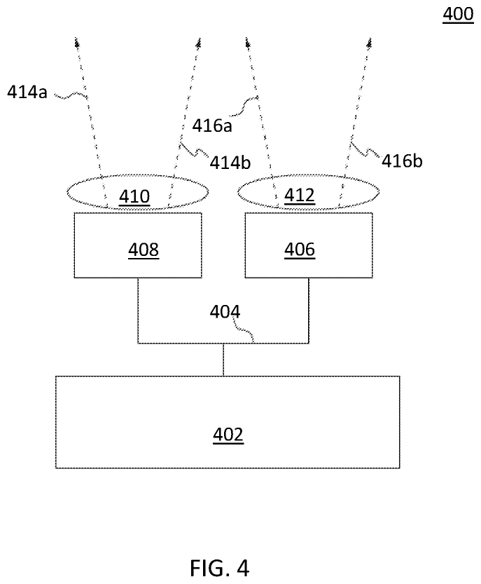

FIG. 4 is a diagram of another example vehicle headlamp system 400. The example vehicle headlamp system 400 illustrated in FIG. 4 includes an application platform 402, two lighting devices 406 and 408, and optics 410 and 412. The lighting devices 406 and 408 may be LED lighting systems, such as the lighting device 100 or 100′ of FIG. 1A or FIG. 2A, or may include the lighting device 100 or 100′ plus some of all of the other modules in the vehicle headlamp system 300 of FIG. 3. In the latter embodiment, the lighting devices 406 and 408 may be vehicle headlamp sub-systems.

The lighting device 406 may emit light beams 416 (shown between arrows 416a and 816b in FIG. 4). In the embodiment shown in FIG. 4, a secondary optic 410 is adjacent the lighting device 408, and the light emitted from the lighting device 408 passes through the secondary optic 410. Similarly, a secondary optic 412 is adjacent the lighting device 406, and the light emitted from the lighting device 406 passes through the secondary optic 412. In alternative embodiments, no secondary optics 410/412 are provided in the vehicle headlamp system.

Where included, the secondary optics 410/412 may be or include one or more light guides. The one or more light guides may be edge lit or may have an interior opening that defines an interior edge of the light guide. Lighting devices 408 and 406 (or the active headlamp of a vehicle headlamp sub-system) may be inserted in the interior openings of the one or more light guides such that they inject light into the interior edge (interior opening light guide) or exterior edge (edge lit light guide) of the one or more light guides. In embodiments, the one or more light guides may shape the light emitted by the lighting devices 408 and 406 in a desired manner, such as, for example, with a gradient, a chamfered distribution, a narrow distribution, a wide distribution, or an angular distribution.

The application platform 402 may provide power and/or data to the lighting devices 406 and/or 408 via lines 404, which may include one or more or a portion of the power lines 302 and the data bus 304 of FIG. 3. One or more sensors (which may be the sensors in the example vehicle headlamp system 300 or other additional sensors) may be internal or external to the housing of the application platform 402. Alternatively, or in addition, as shown in the example vehicle headlamp system 300 of FIG. 3, each lighting device 408 and 406 may include its own sensor module, connectivity and control module, power module, and/or LED array.

In embodiments, the vehicle headlamp system 400 may represent an automobile with steerable light beams where LEDs may be selectively activated to provide steerable light. For example, an array of LEDs may be used to define or project a shape or pattern or illuminate only selected sections of a roadway. In an example embodiment, infrared cameras or detector pixels within lighting device 406 and 408 may be sensors (e.g., similar to sensors in the sensor module 310 of FIG. 3) that identify portions of a scene (e.g., roadway or pedestrian crossing) that require illumination.

The features and example embodiments of the invention described above may equally pertain to the different aspects according to the present invention. In particular, with the disclosure of features relating to the lighting device according to the first aspect, also corresponding features relating to the automotive lighting system according to the second aspect or to the method according to the third aspect are disclosed. It is to be understood that the presentation of embodiments in this section is exemplary and non-limiting.

What is claimed is:

1. A lighting device comprising:
an electrically insulating layer;
at least one first light emitting element on the electrically insulating layer and configured to emit light of a first color;
at least one second light emitting element on the electrically insulating layer and configured to emit light of a second color; and
at least one electrical contact element at least in part on the electrically insulating layer and is electrically coupled to at least one of the at least one first light emitting element or the at least one second light emitting element.

2. The lighting device according to claim 1, further comprising an interface layer, the electrically insulating layer being on the interface layer.

3. The lighting device according to claim 1, wherein the first color is different from the second color.

4. The light device according to claim 1, at least one of the first color or the second color are selected from the group consisting of a white color, an amber color and a cyan color.

5. The lighting device according to claim 1, wherein the electrically insulating layer comprises a connection portion on which the at least one electrical contact element is disposed and a mounting portion on which the at least one first light emitting element and the at least one second light emitting element are disposed, wherein a thickness of the connection portion being smaller than a thickness of the mounting portion.

6. The lighting device according to claim 5, wherein the mounting portion and the connection portion are adjacent each other forming a step at a transition from the connection portion to the mounting portion.

7. The lighting device according to claim 5, wherein the at least one first light emitting element and the at least one second light emitting element are disposed at least in part inside of the mounting portion.

8. The lighting device according to claim 5, wherein the at least one electrical contact element comprises an essentially planar contact portion and is arranged on the electrically insulating layer within the connection portion.

9. The lighting device according to claim 1, wherein the at least one first light emitting element and the at least one second light emitting element are adjacent to each other, such that respective light emission surfaces of the at least one first light emitting element and the at least one second light emitting element are arranged in a common plane.

10. The lighting device according to claim 1, wherein the at least one electrical contact element comprises three electrical contact elements, two of the three electrical contact elements being respectively electrically coupled a corresponding one of the at least one light emitting element and the at least one second light emitting element, and one of the at least three electrical contact elements being electrically coupled to both of the at least one first light emitting element and the at least one second light emitting element.

11. The lighting device according to claim 1, wherein the at least one electrical contact element comprises at least a first, a second, a third and a fourth electrical contact element, the at least one first light emitting element being electrically coupled to the first and the second contact element, and the at least one second light emitting element being electrically coupled to the third and the fourth contact element.

12. An automotive lighting system comprising:
a lighting device comprising:
an electrically insulating layer,
at least one first light emitting element on the electrically insulating layer and configured to emit light of a first color,
at least one second light emitting element on the electrically insulating layer and configured to emit light of a second color, and
at least one electrical contact element at least in part on the electrically insulating layer and is electrically coupled to at least one of the at least one first light emitting element or the at least one second light emitting element

13. The automotive lighting system according to claim 12, further comprising
at least one optical element configured to shape a beam of light emitted from the at least one first light emitting element and the at least one second light emitting element.

14. The automotive lighting system according to claim 12, further comprising
a controller configured to respectively control at least one of the at least one light emitting element or the at least one second light emitting element to be turned at least one of ON or OFF in accordance with at least one predetermined mode of operation.

15. The automotive lighting system according to claim 14, wherein the first color is a white color, and the predetermined mode of operation comprises a daytime running mode in which the controller is configured to turn ON the at least one first light emitting element and turn OFF the at least one second light emitting element.

16. The automotive lighting system according to claim 14, wherein the second color is an amber color, and the predetermined mode of operation comprises a turn-signal mode in which the controller is configured to periodically turn ON and OFF the at least one second light emitting element and turn OFF the at least one first light emitting element.

17. The automotive lighting system according to claim 14, wherein the first color is a cyan color, and the predetermined mode of operation is a first autonomous driving mode in which the controller is configured to turn ON the at least one first lighting element and turn OFF the at least one second light emitting element.

18. The automotive lighting system according to claim 14, wherein the second color is a cyan color, and the predetermined mode of operation comprises a second autonomous driving mode in which the controller is configured to turn OFF the at least one first light emitting element and turn ON the at least one second light emitting element.

19. A method of producing a lighting device comprising:
providing an electrically insulating layer;
providing at least one first light emitting element configured to emit light of a first color and at least one second light emitting element configured to emit light of a second color;
arranging the at least one first light emitting element and the at least one second light emitting on the electrically insulating layer;
providing at least one electrical contact element;
arranging the at least one electrical contact element at least in part on the electrically insulating layer; and
electrically coupling the at least one electrical contact element to at least one of the at least one first light emitting element or the at least one second light emitting element.

20. The method of claim 19, further comprising arranging the electrically insulating layer on an interface layer.
